(19) United States
(12) Patent Application Publication
(10) Pub. No.: US 2002/0107977 A1
(43) Pub. Date: Aug. 8, 2002

(54) Multi-server system dynamic re-configuration

(76) Inventors: Andrew Dunshea, Auckland (NZ); David J. McCarty, Vence (FR); Vijay Seetharaman, Lower Hutt (NZ)

Correspondence Address: Ronald L. Drumheller, Esq., 94 Teakettle Spout Road, Mahopac, NY, 10541, US

(21) Appl. No.: 09/732,144

(22) Filed: Dec. 7, 2000

(51) Int. Cl. G06F 15/173; G06F 15/16

(52) U.S. Cl. 709/238; 709/219; 709/203

(57) ABSTRACT

In a client-server computing environment, a server machine 36 has facility for dynamically reconfiguring the server processes that it supports. A Server Request Broker 50 receives service requests. A middleware 44 of the SRB 50 routes the service request to a queue residing within a queue subsystem 70, in accordance with a mapping provided by a configuration subsystem 60. Two server processes 80, 82 are directed to one or more of the service queues 72-76, determined by a further Mapping Table 64 held by the configuration subsystem 60. For a particular service request, read by a particular service process, a Mapping Table 66 directs the server process to an appropriate library 90 entry point. Dynamic reconfiguration is achieved by amending either, or both of the Mapping Tables 62-64.

### FIELD OF THE INVENTION

This invention relates to distributed computing systems having multiple server processes that can be dynamically configured to change the arrangement of servers that can execute service requests.

### BACKGROUND OF THE INVENTION

In modem large computing systems a common topology has three (logical and/or physical) tiers: (i) a presentation tier characterized by multiple workstations focusing on user interactions, (ii) a business tier characterised by multiple servers executing application/business logic, and (iii) a data tier characterized by multiple databases working on data storage and organization. A Local or Wide Area Network (LAN/WAN) interconnects the three tier elements.

Such computing systems find application in many and varied fields, ranging from university research and teaching facilities to business applications. In fact, almost every business will utilise such a system to transact its functions and serve its clients. For example, a system may be used to control inventory, for word processing and accounts purposes, and for servicing client's enquiries. Many businesses have very large client bases and may provide an extensive inventory of goods and services. One illustrative example is a telecommunications service provider (Telco) that serves a countrywide client base. The Telco's subscribers thus can number in the millions, and each customer will expect a near immediate response from a Customer Service Representative (CSR) to any inquiry, which can range from billing information, a request for a new service, or the placing of orders for a product.

Similar examples are seen in Utilities, insurance companies, banks, hospitals, law firms, accountancy firms, stock exchanges, universities, and Government agencies, to name but a few.

In all such computing systems there is an inherent tension between software and hardware resources. As customer demand, and the complexity of goods and services provided increases, it is economically inefficient and technically limited simply to attempt to increase the sizing of computing hardware.

In a multi-server environment it is known to dedicate each server to a particular process or application through the use of background daemon processes, written as UNIX™ executables. FIG. 1 shows such a prior art arrangement.

The computing system 10 comprises a number of workstations (W1 . . . Wn) 12, 14, and a generic network 16 connected to a front-end Work Load Manager (WLM) 18. Three servers (S1, S2, S3) are connected to, and under the control of the WLM 18. Each server 20-24 has a dedicated or identified role. The server S1 performs database functions by retrieval and storage of data to the database (DB1) 26. The server S2 acts as a gateway for access to the Internet 28. The server S3 is dedicated to supporting word processing operations.

For any of the servers S1-S3 to perform a different processor application requires the server to be shut down and reconfigured. Additionally, the WLM 18 is required to be reconfigured so that it has knowledge of the process or applications supported by each individual server 20-24. Such reconfiguration requirements are undesirable from the point of view of lost operational time and maintenance costs. For a computing system where there are a large number of servers, it is desirable to make the best use of that resource by way of load balancing. Where servers have a fixed functionality it is not possible to provide for a redistribution of processes or applications without performing some form of off-line reconfiguration.

A specific known technique is the use of Dynamic Link Libraries (DLL), such as the CICS™ Scheduler of International Business Machines Corporation. Such libraries contain a range of supportive functionality. At start-up time, each server S1-S3 is instructed by the WLM 18 to upload the specified processor application with reference to the DLL. This DLL information is captured in configuration files, which are static, meaning that configuration of the servers can only occur at start-up time.

It is an object of the present invention to provide for the dynamic reconfiguration of multiple servers to execute service requests.

### SUMMARY OF THE INVENTION

The invention provides a method for the execution of client service requests in a multi-server system having the capability of reconfiguration of server process-to-service requests, the method comprising the steps of:

(a) passing a said client request to one of a plurality of service queues;

(b) dynamically mapping each one of a plurality of server processes to one or more of said service queues;

(c) mapping each said service request to a database library point containing respective service execution code; and

(d) for a server process listening to a queue, retrieving appropriate code from said database library upon receiving a queued service request by making reference to said mapping; and

whereby said dynamic mapping reconfigures the possible server processes that can execute any service request residing in any of said service queues.

The invention further provides a method for the execution of client service requests in a multi-server system having the capability of server-to-service requests, the method comprising the steps of:

(a) receiving and dynamically passing a said request from a router to a chosen one of a plurality of service queues;

(b) mapping each one of a plurality of server processes to one or more of said service requests;

(c) mapping each said service request to a database library point containing respective service execution code; and

(d) for a server process listening to a queue, retrieving appropriate code from said database library upon receiving a queued service request with reference to said mapping; and

whereby said dynamic passing of service requests to service queues reconfigures the possible server processes that can execute any service request residing in any of said service queues.

The invention yet further provides a system for executing client service requests, and having capability of reconfiguration of server process-to-service requests, comprising:

(a) a router receiving client service requests;

(b) a plurality of server processes;

(c) a configuration control means, being in communication with said service request brokers and said servers, to provide mapping information thereto;

(d) a plurality of services queues, to which said router can pass service requests, each said service request being passed to one of said service queues in accordance with a service-to-queue mapping, and to each of which queues one or more of said server processes listen for queued service requests in accordance with a server-to-queue mapping; and

(e) a database library containing code required to execute service requests, from which said server processes retrieve the respective code for a queued service request read from a connected said queue in accordance with a library-to-service mapping; and

wherein said configuration subsystem can dramatically reconfigure the possible server processes that can execute any service request residing in any of said service queues by changing the server-to-queue mapping.

The invention yet further provides a client-server computing system comprising:

one or more client machines from which service requests issue;

one or more client machines for servicing said requests; and

a network interconnecting said client machines with said server machines; and

wherein said servers are dynamically reconfigurable to execute chosen server requests, in that each said server includes:

(a) a router receiving client service requests;

(b) a plurality of server processes;

(c) a configuration control means, being in communication with said service request brokers and said servers, to provide mapping information thereto;

(d) a plurality of services queues, to which said router can pass service requests, each said service request being passed to one of said service queues in accordance with a service-to-queue mapping, and to each of which queues one or more of said server processes listen for queued service requests in accordance with a server-to-queue mapping; and

(e) a database library containing code required to execute service requests, from which said server processes retrieve the respective code for a queued service request read from a connected said queue in accordance with a library-to-service mapping; and

wherein said configuration subsystem can dramatically reconfigure the possible server processes that can execute any service request residing in any of said service queues by changing the server-to-queue mapping.

The invention yet further provides a computing system comprising:

one or more client machines from which service requests issue;

one or more client machines for servicing said requests; and

a network interconnecting said client machines with said server machines: and

wherein each said server includes a service request broker linked with one or more server processes that, in turn, can call data libraries for code for respective service requests, and said service request broker can dynamically reconfigured to which one or more server processes execute which one or more service requests.

In one form, Mapping Tables are stored in the configuration subsystem as mapping entries. During dynamic reconfiguration, the mapping entries can be overwritten in one or more of the tables. Additionally, the configuration subsystem can dynamically reconfigure the server queue to which any service request can be directed to by changing the service-to-queue mapping.

### BRIEF DESCRIPTION OF THE DRAWINGS

Embodiments of the invention will now be described with reference to the accompanying drawings, in which:

FIG. 1 shows a prior art multi-server computing system;

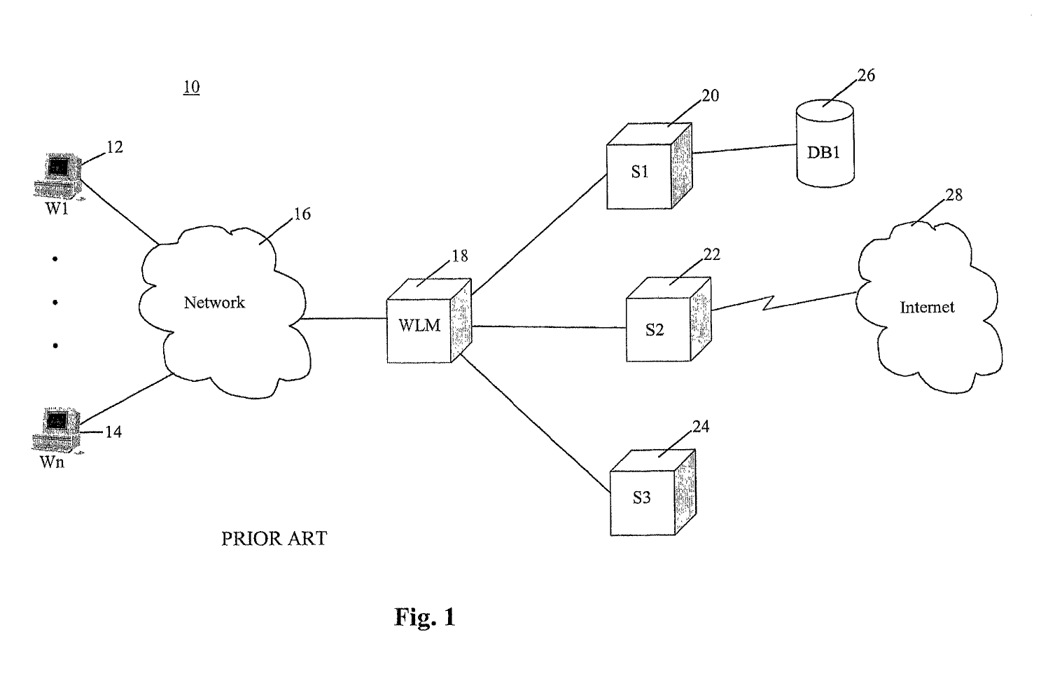

FIG. 2 shows a multi-server computing system embodying the invention;

FIG. 3 shows a generalised client-server software architecture diagram;

FIG. 4 is a client-server software architecture system in accordance with the invention;

FIG. 5 is a process diagram relating to the server;

FIG. 6 is a process diagram similar to FIG. 5;

FIG. 7 is a process diagram similar to FIG. 6; and

FIG. 8 is a process diagram relating to the client.

### DETAILED DESCRIPTION OF EMBODIMENTS AND BEST MODE

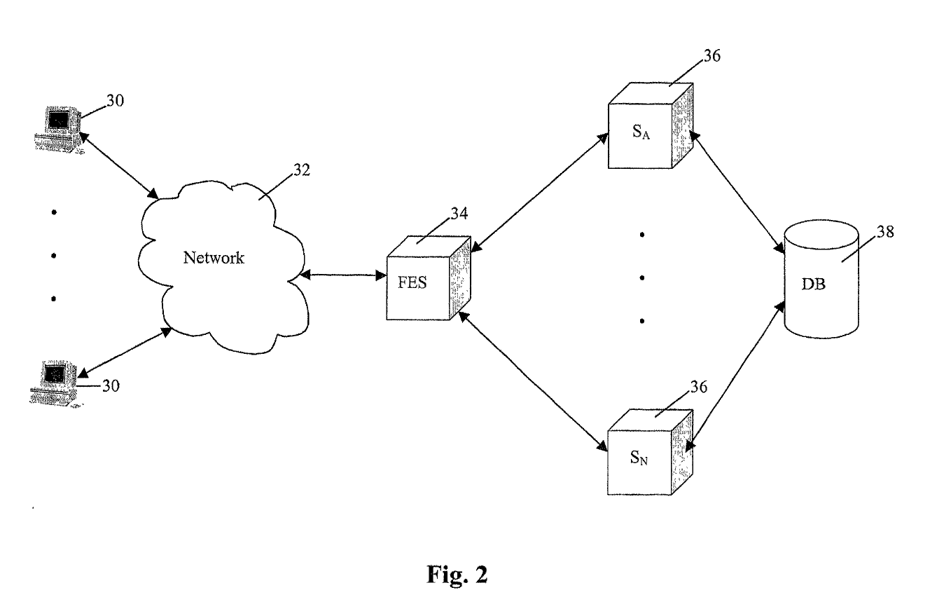

In FIG. 2, a plurarity of client workstations (“clients”) 30 transmit servicing requests on a WAN/LAN 32 Network to a Front End Server (FES) 34. The FES 34 has communication with a plurality of application servers (S_{A}-S_{N}) 36. The application servers 36 store and retrieve data from a database (DB) 38. Only a single database has been shown for the sake of convenience, however it will be appreciated that there equally can be multiple databases and/or database servers for particular implementations. In a similar way, the function performed by the FES 34 could reside in one or more of the application servers 36.

In the sense of the hardware platform of FIG. 2, a client 30 issues a service request that is received by the FES 34. Depending upon the allocation of the application servers 36 connected to the FES 34, one of those servers will execute the service request. The application servers 36 each perform one or more server processes (in a software sense). The invention is concerned with the dynamic reallocation of service request processing by the server processes 36.

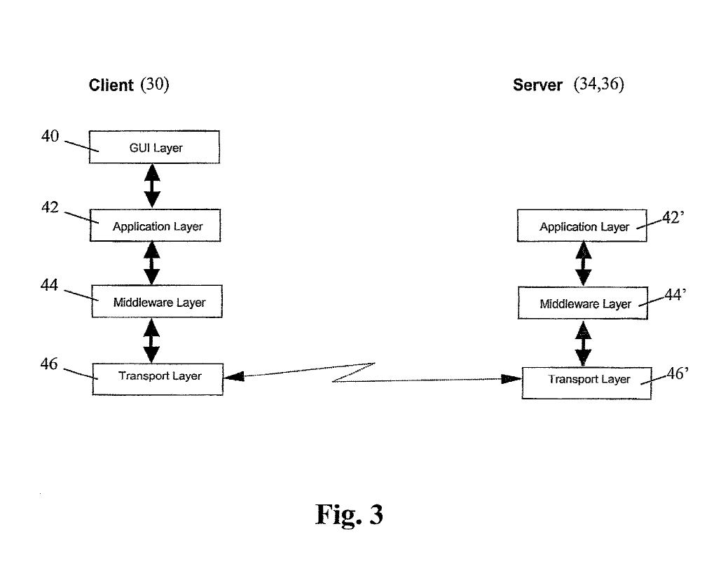

FIG. 3 is a generalised software architecture for a client-server environment. On the client machine 30, a Graphical User Interface (GUI) layer 40 provides the human-machine interface for a user. The GUI layer interfaces with an application layer 42, where the specific computing operation or purpose performed by the client-server system resides. The application layer interfaces with a middleware layer 44 that handles aspects such as system resource usage, operating system locks, shared memory access, container services, queuing services, transaction services, logical unit of work coordination, inter-process communications, user access control services, and configuration retrieval services. The middleware layer represents the operating system and communications services. In an Object Oriented environment, objects are instantiated by the middleware in response to service requests. The transport layer 46 of the client machine 30 is in network communication with the server machine 34,36, usually transmitting a binary string representation of an object. The server machine replicates the transport layer 46′, the middleware layer 44′, and the application layer 42′ functions.

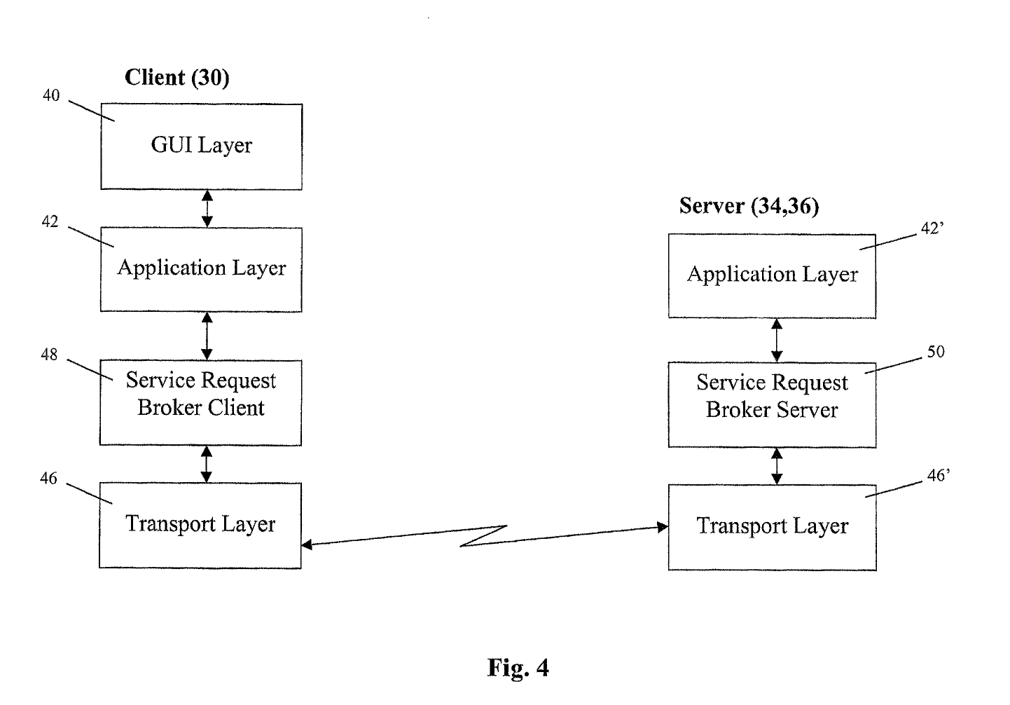

FIG. 4 shows a software architecture diagram where the conventional middleware layer is replaced by a Client Service Request Broker (SRB-C) 48 and a Server Service Request Broker (SRB-S) 50.

Server SRB

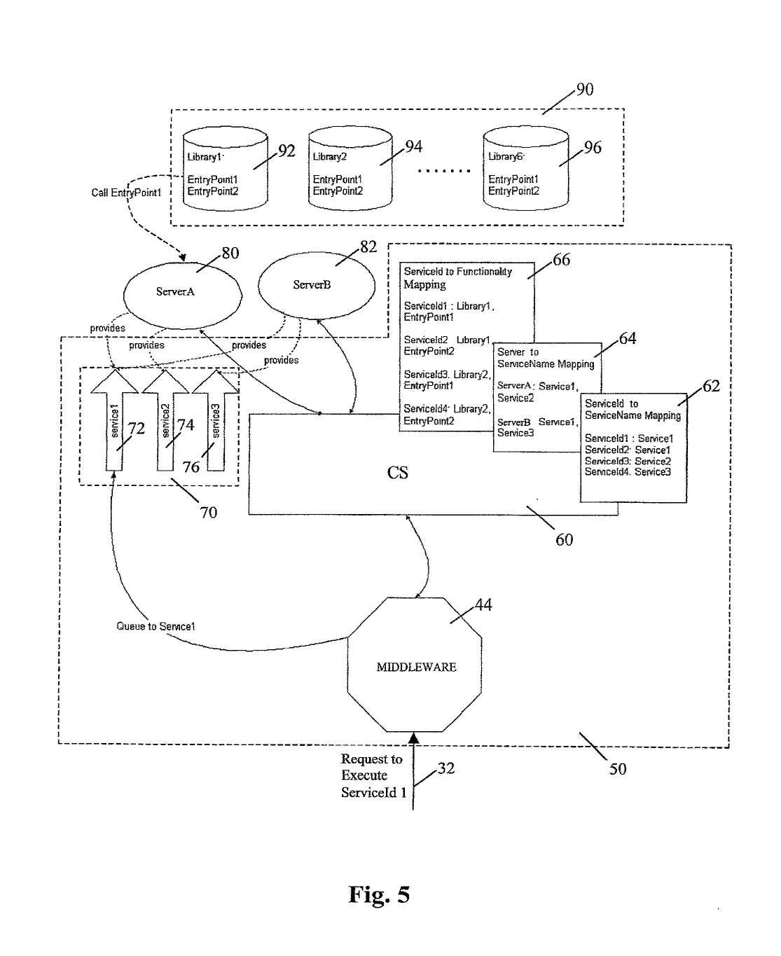

FIG. 5 is a process diagram relating to the Server, which represents the SRB-S 50 interface with the Application Layer 42′.

Service requests, existing within a customer goods and services ordering system, can be such as: STORE, CREATE CUSTOMER, RETRIEVE CONTACT DETAILS, and CREATE PRODUCT REQUEST. Such service requests, in the form of a “ServiceID”, are received by the SRB-S 50 on a data channel 32 from the Transport Layer 46′.

The SRB-S 50 is firstly constituted by conventional middleware 44, which can be any one of the CICS™, ENCINA™ or CBConnector™ products of International Business Machines Corporation. The middleware performs the functions described above. From the point of view of the invention, it acts as a router.

The SRB-S 50 also contains a Configuration Subsystem (CS) 60. The CS 60 provides configuration information required to execute service requests. This information is maintained in the form of relational tables or a flat file. The CS 60 can be implemented by any convenient relational database, such as the DB2™ product of International Business Machines Corporation, accessed via SQL call commands. If the information is implemented as flat files, on the other hand, then simple operating system calls can be utilized.

FIG. 5 shows three such relational tables:

(a) ServiceID to ServiceName Mapping Table, 62

(b) Server to ServiceName Mapping Table, 64

(c) ServiceID to Functionality Mapping Table, 66

The SRB-S 50 also includes a queuing subsystem 70, which incorporates a number of queues 72-76 in which service objects are held until executed by a process server. The queuing subsystem 70 can be implemented as the MQueue™ Series of International Business Machines Corporation.

FIG. 5 further shows two server processes 80, 82 (viz., ServerA and ServerB), which link to the CS 60 and look into the queues 72-76 of the queuing subsystem 70. Only two server processes have been shown for ease of explanation. The server processes 80, 82 can be implemented as UNIX™ daemon background processes.

A Dynamic Link Library Management Subsystem (DLL) 90 contains a plurality of libraries 92-96 which are called upon by the server processes 80, 82 to load the program required to execute a service request (i.e. a Library Entry Point). If the server processes are implemented in UNIX, then an appropriate format for the DLL 90 is as a Shared Object (.so) library.

Execution of Service Requests

The servers processes 80, 82 are configured at any particular time to support one or more applications. In the example shown in FIG. 5, the queuing subsystem 70 contains three queues (there can, of course, be a greater number), described as “service1”, “service2”, and “service3”. Each queue can be supported by one or more server processes 80, 82. For each service request received by the routing middleware 44, the request itself is defined with a unique identifier: “ServiceId”. The ‘ServiceId to ServiceName Mapping’ Table 62 is available to the middleware 44. In this case, the mapping of ServiceId's to the possible service queues is:

| ServiceID | ServiceName |
|---|---|
| ServiceId1 | Service1 |
| ServiceId2 | Service1 |
| ServiceId3 | Service2 |
| ServiceId4 | Service3 |

Any ServiceId (i.e. an application servicing request) can only be mapped to a single service queue 72-76.

From the Server to Service Name Mapping Table 64 shown in FIG. 5, it can be seen that ServerA supports ‘service1’ and ‘service2’, and Server B supports ‘service1’ and ‘service3’. These servicing arrangements are demonstrated by the dashed lines. ServerA thus can read the contents of the service1 and the service2 queues 72, 74, and will execute any application it reads from either queue. Server B reads, and executes applications placed in the service1 and service3 queues 72, 76.

In order for either ServerA and ServerB to retrieve the correct application code from the DLL 90, they need to have knowledge of the ServiceIDs and the related libraries 92, 96. This is provided by the ‘ServiceID to Functionality Mapping’ Table 64. In this case, the ServiceID points to a library and entry point:

| ServiceID | Functionality |
|---|---|
| ServiceId1: | Library 1, Entry Point1 |
| ServiceId2: | Library 1, EntryPoint2 |
| ServiceId3: | Library2, EntryPoint1 |
| ServiceId4: | Library 2, Entry Point2 |

Consider then the specific example shown in FIG. 5, where the service request received by the SRB 50 is ‘ServiceId’ 1 routed by the middleware 44, then mapped to the service1 queue 72. Both ServerA and ServerB read the service1 queue 72, and either is free to execute the servicing request. In this case, serverA reads the service1 queue first, and by consulting the relevant Mapping Table 66, calls EntryPoint1 for Library1 to retrieve the relevant application code.

The service is then executed by application processors (not shown), and a reply or result returned to the originating client machine 30.

Dynamic Reconfiguration

In accordance with the invention, dynamic configuration of the server processes 80, 82 can occur by reconfiguring the ‘Server to ServiceName Mapping’ Table 64. For example, an additional server process can be added, or an existing server process can be instructed to read none of, or different ones of, the service queues 72-76. This reconfiguration can be performed at any time, and does not require recompiling of any code.

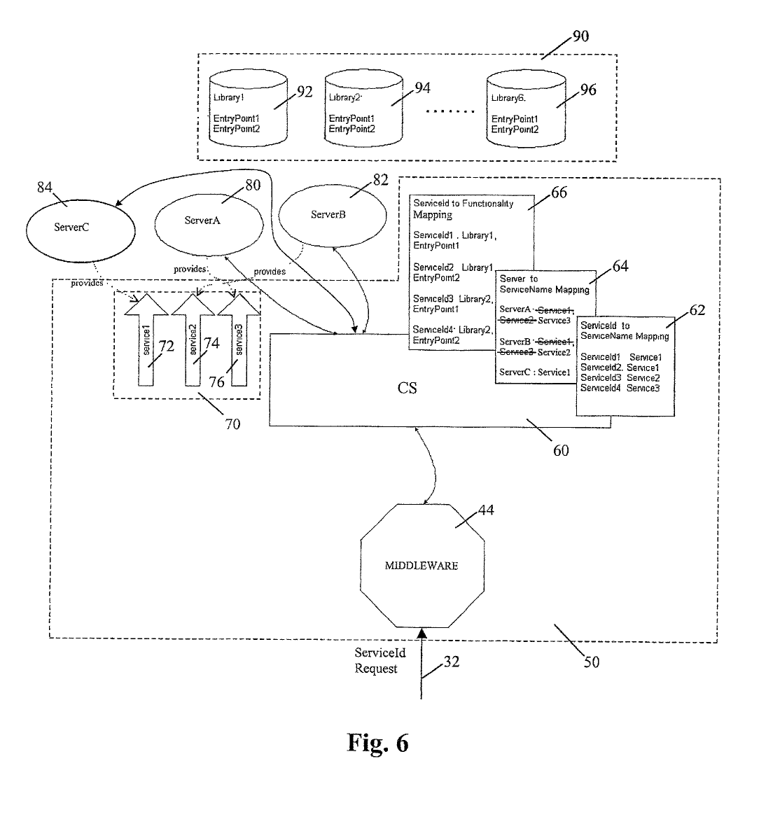

FIG. 6 shows such a dynamic reconfiguration whereby a new server process 84 (ServerC) has been added, and each server process 80-84 now only looks at a single queue 72-76. Specifically, ServerA now looks at the service3 queue 76, ServerB now looks at the service2 queue 74, and ServerC looks at the service1 queue 72. The reconfiguration is shown in the changes to the Mapping Table 64.

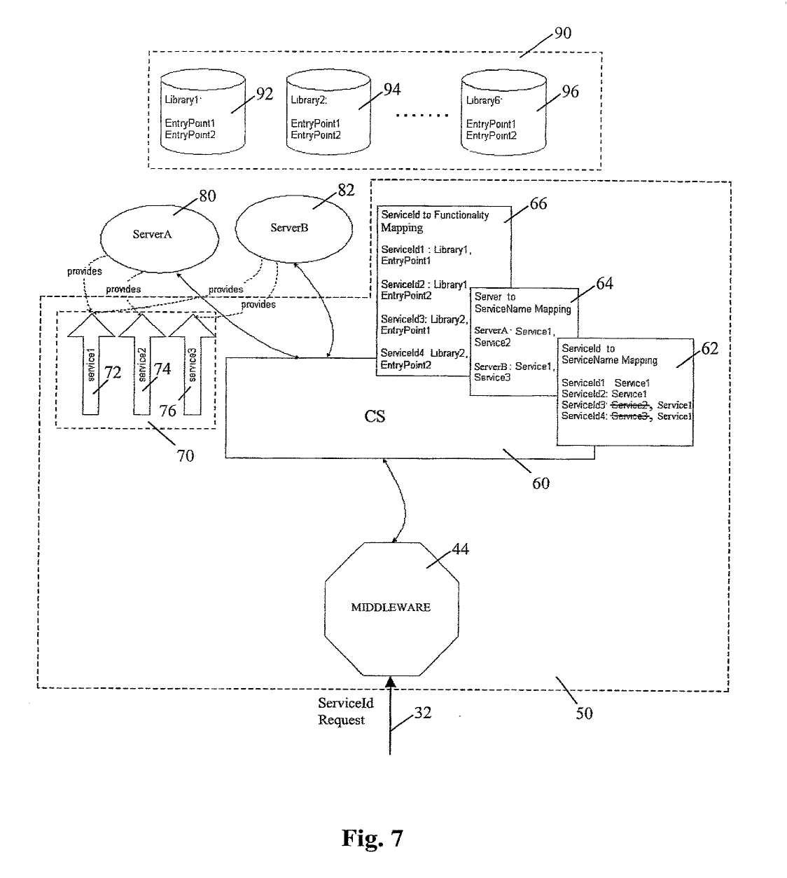

In a similar manner, dynamic reconfiguration can be performed by changing the ‘ServiceID to ServiceName Mapping’ Table 62, such that specific ServiceIds can be redirected to different service queues 72-76. Consider the reconfiguration such that all ServiceIds are directed only to the service1 queue 72. The Mapping Table 62 utilized by the middlewear 44, in amended form, is shown in FIG. 7. In this case, it remains that both ServerA and ServerB can executed all ServiceID requests, now appearing only on the service1 queue 72.

It is, of course, possible to achieve dynamic reconfiguration by both of the methods described acting together.

Client SRB

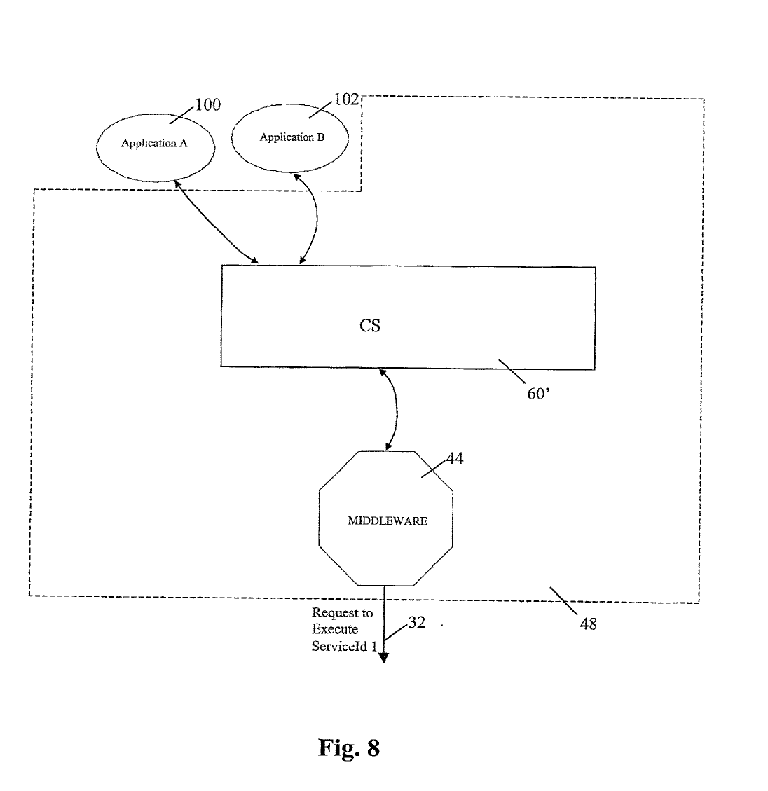

FIG. 8 shows the SRB-C 48 implementation. It is a reduced form of the Server SRB 50. The configuration subsystem (CS) 60′ has the function of mapping application program requests to target server machines 36, including the respective logical address. The CS 60′ communicates with the middleware 44, that provides the transport functionality such that a ServiceId is issued and directed correctly to the target server 36.

The CS 60′ receives service requests from associated application programs, shown as ApplicationA 100 and ApplicationB 102. While two such application programs have been shown, it is also possible for there to be one, three or more.

The CS 60′ is not required to hold the Mapping Tables 62-66 of the equivalent CS 60 of the Server SRB 50.

The motivation for dynamic reconfiguration (by either technique described) includes achieving load balancing, expansion of computing hardware (upgrading), or maintenance of hardware (off-line) purposes.

It will be appreciated by those skilled in the art that numerous alterations and modifications can be made without departing from the inventive concepts described. All such modifications and alterations are to be understood as incorporated herein.

We claim:

1. A method for the execution of client service requests in a multi-server system having the capability of reconfiguration of server process-to-service requests, the method comprising the steps of:
(a) passing a said client request to one of a plurality of service queues;
(b) dynamically mapping each one of a plurality of server processes to one or more of said service queues;
(c) mapping each said service request to a database library point containing respective service execution code; and
(d) for a server process listening to a queue, retrieving appropriate code from said database library upon receiving a queued service request by making reference to said mapping; and
whereby said dynamic mapping reconfigures the possible server processes that can execute any service request residing in any of said service queues.

2. The method of claim 1, whereby step (b) includes the steps of:
storing a mapping table having entries mapping said server processes to said server queues; and
for each server process, writing the server queue information to the respective said server process.

3. The method of claim 2, comprising the further step of performing a reconfiguration by overwriting one or more of said table entries.

4. The method of claim 1, further whereby step (a) is also dynamically configurable so that any said request can be received by, and directed from a router to a chosen one of said service queues.

5. The method of claim 4, whereby step (a) includes the steps of:
storing a mapping table having entries mapping said client requests to said service queues; and
for each client service writing the server queue information to said router.

6. The method of claim 5, comprising the further step of performing a reconfiguration by overwriting one or more of said table entries.

7. A method for the execution of client service requests in a multi-server system having the capability of server-to-service requests, the method comprising the steps of:
(a) receiving and dynamically passing a said request from a router to a chosen one of a plurality of service queues;
(b) mapping each one of a plurality of server processes to one or more of said service requests;
(c) mapping each said service request to a database library point containing respective service execution code; and
(d) for a server process listening to a queue, retrieving appropriate code from said database library upon receiving a queued service request with reference to said mapping; and
whereby said dynamic passing of service requests to service queues reconfigures the possible server processes that can execute any service request residing in any of said service queues.

8. The method of claim 7, whereby step (a) includes the steps of:
storing a mapping table having entries mapping said client requests to said service queues; and
for each client service writing the server queue information to said router.

9. The method of claim 8, comprising the further step of performing a reconfiguration by overwriting one or more of said table entries.

10. The method of claim 7, further whereby said step (b) is also dynamically configurable in mapping said server processes to said service requests.

11. The method of claim 10, whereby step (b) includes the steps of:
storing a mapping table having entries mapping said server processes to said server queues; and
for each server process, writing the server queue information to the respective said server process.

12. The method of claim 11, comprising the further step of performing a reconfiguration by overwriting one or more of said table entries.

13. A system for executing client service requests, and having capability of reconfiguration of server process-to-service requests, comprising:
(a) a router receiving client service requests;
(b) a plurality of server processes;
(c) a configuration control means, being in communication with said service request brokers and said servers, to provide mapping information thereto;
(d) a plurality of services queues, to which said router can pass service requests, each said service request being passed to one of said service queues in accordance with a service-to-queue mapping, and to each of which queues one or more of said server processes listen for queued service requests in accordance with a server-to-queue mapping; and
(e) a database library containing code required to execute service requests, from which said server processes retrieve the respective code for a queued service request read from a connected said queue in accordance with a library-to-service mapping; and
wherein said configuration subsystem can dramatically reconfigure the possible server processes that can execute any service request residing in any of said service queues by changing the server-to-queue mapping.

14. The system of claim 13, wherein said configuration subsystem stores said mapping information as tables having mapping entries.

15. The system of claim 14, wherein dynamic reconfiguration is performed by overwriting one or more entries in said tables.

16. The system of claim 13, wherein said configuration subsystem can dynamically reconfigure the server queue to which any service request can be directed to by changing the service-to-queue mapping.

17. The system of claim 16, wherein said configuration subsystem stores said mapping information as tables having mapping entries.

18. The system of claim 17, wherein dynamic reconfiguration is performed by overwriting one or more entries in said tables.

19. A client-server computing system comprising:
one or more client machines from which service requests issue;
one or more client machines for servicing said requests; and
a network interconnecting said client machines with said server machines; and
wherein said servers are dynamically reconfigurable to execute chosen server requests, in that each said server includes:
(a) a router receiving client service requests;
(b) a plurality of server processes;
(c) a configuration control means, being in communication with said service request brokers and said servers, to provide mapping information thereto;
(d) a plurality of services queues, to which said router can pass service requests, each said service request being passed to one of said service queues in accordance with a service-to-queue mapping, and to each of which queues one or more of said server processes listen for queued service requests in accordance with a server-to-queue mapping; and
(e) a database library containing code required to execute service requests, from which said server processes retrieve the respective code for a queued service request read from a connected said queue in accordance with a library-to-service mapping; and
wherein said configuration subsystem can dramatically reconfigure the possible server processes that can execute any service request residing in any of said service queues by changing the server-to-queue mapping.

20. The computing system of claim 19, wherein said configuration subsystem stores said mapping information as tables having mapping entries.

21. The computing system of claim 20, wherein dynamic reconfiguration is performed by overwriting one or more entries in said tables.

22. The computing system of claim 19, wherein said configuration subsystem can dynamically reconfigure the server queue to which any service request can be directed to by changing the service-to-queue mapping.

23. The computing system of claim 22, wherein said configuration subsystem stores said mapping information as tables having mapping entries.

24. The computing system of claim 23, wherein dynamic reconfiguration is performed by overwriting one or more entries in said tables.

25. A computing system comprising:
one or more client machines from which service requests issue;
one or more client machines for servicing said requests; and
a network interconnecting said client machines with said server machines; and
wherein each said server includes a service request broker linked with one or more server processes that, in turn, can call data libraries for code for respective service requests, and said service request broker can dynamically reconfigured to which one or more server processes execute which one or more service requests.

26. The computing system of claim 25, wherein said service request broker includes:
a router receiving service requests;
a configuration subsystem being in communication with said router and said server processes;
a plurality of service queues, to which said router can pass service requests, each said service request being passed t one of said service queues in accordance with a service-to-queue mapping, and to each of which queues one or more of said server processes listen for queued service requests in accordance with a server-to-queue mapping; and
wherein said dynamic reconfiguration is performed by changing the server-to-queue mapping;

27. The computing system of claim 26, wherein said configuration subsystem stores said mapping information as tables having mapping entries.

28. The computing system of claim 27, wherein dynamic reconfiguration is performed by overwriting one or more entries in said tables.

29. The computing system of claim 26, wherein said configuration subsystem can dynamically reconfigure the server queue to which any service request can be directed to by changing the service-to-queue mapping.

30. The computing system of claim 29, wherein said configuration subsystem stores said mapping information as tables having mapping entries.

31. The computing system of claim 30, wherein dynamic reconfiguration is performed by overwriting one or more entries in said tables.
